(19) United States
(12) Patent Application Publication
(10) Pub. No.: US 2021/0253295 A1
(43) Pub. Date: Aug. 19, 2021

(54) FOLD FLAT TRAY AND ASSOCIATED METHOD OF FORMING

(71) Applicant: Rapid Action Packaging Limited, London (GB)

(72) Inventors: Quang Tien PHUNG, Surrey (GB); Hui-Yi WANG, London (GB)

(21) Appl. No.: 17/252,197

(22) PCT Filed: Jun. 20, 2019
(86) PCT No.: PCT/GB2019/051732

§ 371 Date: Dec. 14, 2020

(30) Foreign Application Priority Data
Jun. 20, 2018 (GB) 1810150.1

(51) Int. Cl. B65D 5/36; B31B 50/26; B31B 50/62

(52) U.S. Cl. CPC B65D 5/3657; B31B 2120/302; B31B 50/624; B31B 50/26

(57) ABSTRACT

A fold flat tray having an erect configuration and a fold flat configuration. The erect configuration comprises, a base (1), and first (2) and second (4) side walls and flanges (8, 9) extending outwardly from the top edges of the side walls. The fold flat configuration comprises the two opposing first sidewalls (2) being folded inwardly about their respective fold lines (3) adjacent to the base such that they lay flat against the base. Each of the two opposing second side walls (4) is provided with a straight fold line (10) extending from each corner, across the second side wall and its associated flange (9) in an oblique manner, such that each second side wall has a central portion between two straight fold lines, and two peripheral portions on opposite sides of the straight fold flat lines with respect to the central portion.

The present invention relates to a fold flat tray formed from a folded blank of material.

Trays are widely used in the packaging industry for transporting various items, but primarily food products. Such trays are generally moulded from plastic into a tray portion which may be open at the top or provided with a lid which may be hinged to the tray, or may be a separate component such as a moulded lid fitted to the tray, or a film which is bonded to an upper rim of the tray to close, and in some cases, seal the tray.

The trays are cheap to manufacture, lightweight and have good rigidity owing to the fact that the moulding methods can mould features such as strengthening ribs and/or a rim around the upper edge of the tray which provides high structural rigidity very cheaply and with little additional material at use.

However, the major drawback with such trays is that they cannot be recycled, and the extremely large number of trays that are produced has given rise to a serious environmental problem.

A tray which eliminated, or at least significantly reduced, the amount of plastic required would have enormous environmental benefits. However, as set out above, other than the environmental concerns the plastic trays are extremely effective in terms of their cost and performance. This is difficult to replicate a non-moulded product.

The present invention is concerned with a tray formed from a folded blank of material. Although not limited to a particular material, the present invention is particularly concerned with a fibrous material such as cardboard. Such material can be readily cut into a blank which can then be folded into an assembled tray. It is possible to achieve the desired rigidity in such a tray, for example, by using a relatively thick material, or by including additional features in the blank, which, when folded up, reinforce certain parts of the tray. However, this additional material begins to be counterproductive as it increases the cost of manufacture and the transport cost. There is therefore a challenge in matching the performance of a moulded plastic tray in a folded structure without unduly increasing the amount of material used.

Folded trays are known in which the side walls are formed of a double thickness of material which is folded over on itself to enhance the rigidity of the container. However, in this case, the upper rim of the container is the folded edge between the two parts forming the side wall.

The present invention is particularly concerned with a tray with side walls which have flanges that form an out turned rim in the assembled tray. Such a rim is necessary if a tray is going to be used for a substitute for the numerous plastic containers which have a film lid sealed to the rim.

One advantage that a tray formed for a folded blank of material has over a plastic container is that it can readily be provided in a “fold flat” configuration. A “fold flat” configuration as defined in this specification refers a configuration in which the assembled blank can be folded, in which various parts of the tray are folded so that they overlie on one another to be substantially flat. The tray can then be relatively easily manipulated into an erect configuration in to form the usable tray. This is highly beneficial because if the trays can be transported and stored in the fold flat configuration. They occupy approximately 10% of the space which is occupied if the trays are transported in the erect configuration. This provided an enormous reduction in the transport and storage costs.

However, in order to provide a fold flat configuration, it is necessary for fold lines to extend across at least one of the flanges in multiple locations. However, the provision of a fold line running across the flange compromises its ability to provide structural integrity to the tray in the erect configuration on the flange then becomes prone to buckling.

DE 1199178, EP0178730 and US2010/116144 all disclose fold flat trays having a fold flat configuration with the fold line extending across a side wall and across an adjacent flange. The trays, however, have a relatively complex folding operation which reduces manufacturing speed and increases the cost.

The present invention is aimed at solving the problem of these conflicting requirements.

According to the present invention there is provided a fold flat tray according to claim 1 and a method of claim 12.

Because the straight fold lines required for the fold flat configuration extend across the sidewall and the flange in an oblique manner, when the tray is in the erect configuration, with the flange folded outwardly, the fold line in the flange is out of the plane of the same fold line in the sidewall. The purpose of the flange is to prevent inward and outward deflection of its associated sidewall, as any inward/outward deflection of the sidewall is effectively resisted by the fact that this movement is trying to deform the flange within the plane of the flange. The flange therefore provides a rigidity against such deformation. The presence of the oblique fold line in the flange does not compromise the ability of the flange to resist this deformation. Further, because each of the first sidewalls comprises a flange which is formed of a number of separate panels in the blank which are bonded together, this provides a straightforward way of assembling the tray from the blank.

Under these circumstances, preferably the portions of the flange from the different panels overlap with one another. This provides additional structural integrity to the flanges. Preferably, each of the first sidewalls has end panels which, in the blank, are continuations of the peripheral portion of the adjacent second sidewall and, the end panels being bonded to a central panel forming the central part of the respective first side wall and which extends from the fold line at the base.

By contrast, each of the second sidewalls and the corresponding flange are formed of a single panel in the blank.

The tray may be used without a lid. Alternatively, a lid may be integrally formed in the blank via a fold line adjacent to one or more of the flanges. However, preferably the lid is in the form of a sheet of material bonded to the flanges. This helps to preserve the rigidity of the container.

The film is preferably a plastics film which is adhered or heat sealed to the flanges.

The tray may be of any foldable material, but is preferably a fibrous material such as cardboard. Preferably the card is in the thickness range of 300 to 500 microns. Preferably the fibrous layer has a unit weight of 200 gsm-350 gsm (gsm stands for ‘grams per square metre’ and is a standard measure of the weight of a square metre of paper/card).

The tray may be a laminate material comprising a layer of fibrous material and a film of plastics material adhered to the layer of fibrous material.

The film of plastics material may be applied to the assembled tray, for example using a vacuum forming process. However, preferably, the web of film is adhered to the fibrous layer prior to the blank being cut and formed into the assembled tray. This is a much easier manufacturing process as it simply requires the bonding of two flat layers. As an alternative to a plastics film, the fibrous layer may simply be coated with a plastics material. Such a coating is applied onto the fibrous layer and, as such, in contrast to a film, it cannot form any regions of unsupported plastics material such as to provide windows or additional material for sealing any joints. It does, however, generally require the use of less plastics material.

As set out above, the tray of the present invention may be provided with the plastics lid and lining. It therefore does require the use of some plastics material. However, this is only to provide a barrier layer against absorption of any liquids into the underlying tray material and to provide a lid which may be sealed. Importantly, the main structural integrity of the container is provided by a layer which does not need to be a plastics material and therefor the amount of plastics material required for the tray is greatly reduced.

Further, when used for some foods such as tomatoes, which do not require a layer to prevent moisture absorption, the tray can be completely devoid of plastics material.

If the film represents less than 20% by weight of the tray, it can be processed by most carton board recycling programs as it should be readily removable in a wet environment (such as pulping of waste paper and board).

The use of a compostable film offers more options for disposal.

An example of a tray in accordance with the present invention will now be described with reference to the accompanying drawings in which:

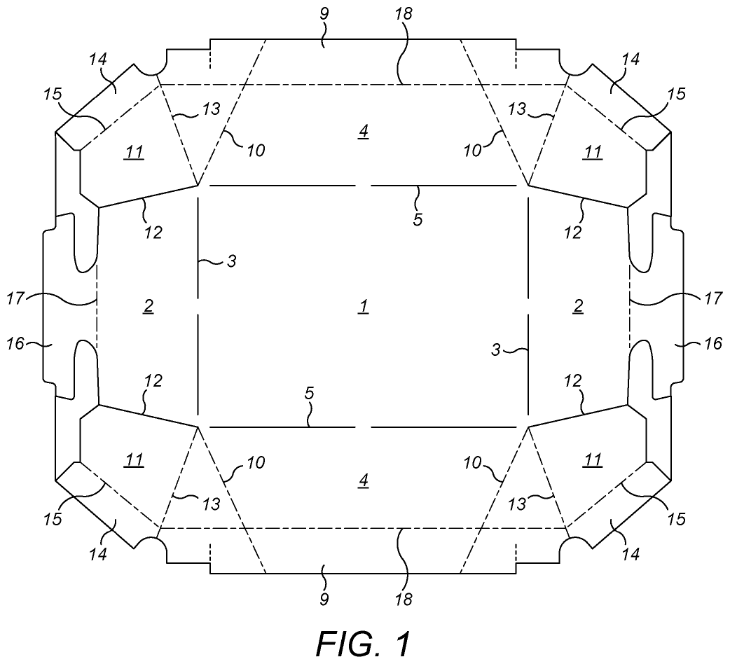

FIG. 1 is a plan view of a blank from which the tray is formed;

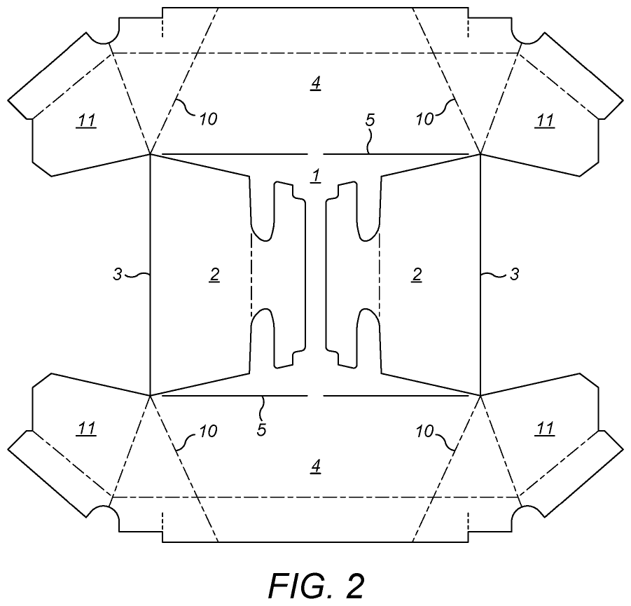

FIG. 2 is a view corresponding to FIG. 1 after a first folding operation on the blank;

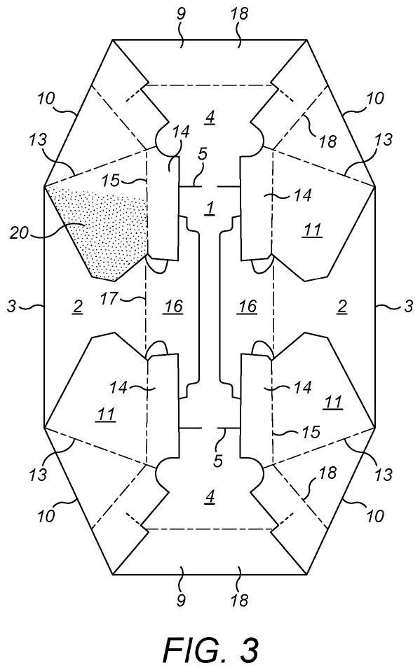

FIG. 3 is a view corresponding to FIGS. 1 and 2 of the finished tray in a fold flat configuration;

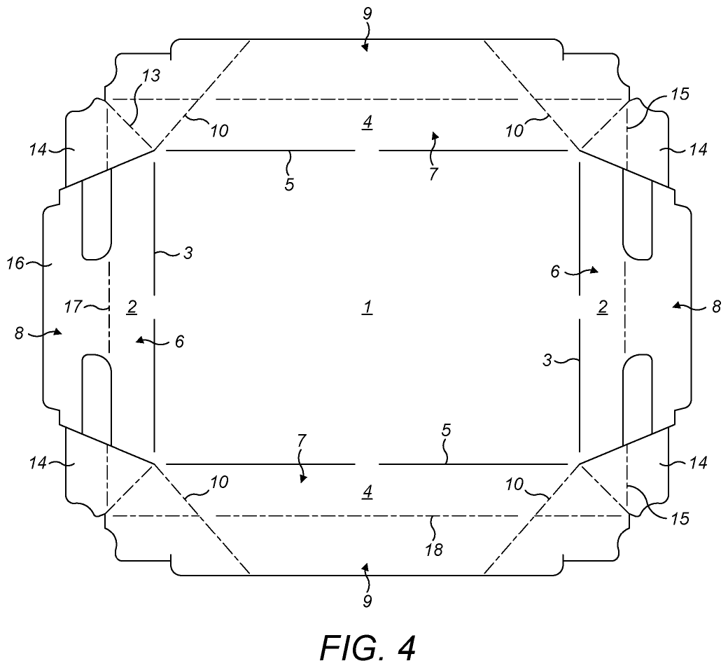

FIG. 4 is a plan view of the tray in the erect configuration; and

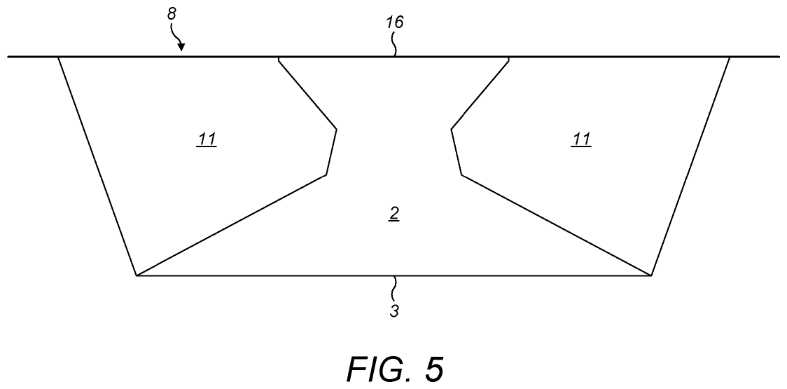

FIG. 5 is a side view of the tray in the erect configuration. The blank shown in FIG. 1 is a planar sheet of foldable material. In the preferred formed, it consists of a laminate of a fibrous layer such as a thin card to which a heat sealable plastics material has been bonded to the upper face.

The blank comprises a base 1 with a pair of first sidewall panels 2 extend from the base via a respective first score line 3 a pair of second sidewall panels 4 orthogonal to the first sidewall panels 2 extending from the base via a respective second score line 5.

These sidewall panels 2, 4 form the central portions of the respective first sidewalls 6 and second sidewalls 7 in the finished tray which are formed from a number of different panels as set out in greater detail below. The first sidewalls 6 are each provided with an out turned flange 8 which is again made up of a number of components as described below, while the second sidewalls 7 are each provided with an out turned flange 9 which are again described below.

Returning to the blank shown in FIG. 1, each of the second sidewall panels 4 is provided with two fold lines 10. Each of these extends from a location at the corner of the base 1 (where it meets the first sidewall panel 2 and second sidewall panel 4). The fold line 10 extends in a straight line fully across the second sidewall panel 4 and the second flange 9.

The second sidewall panel 4 extends to a pair of attachment tabs 11. As is apparent from FIG. 2, these attachment tabs 11 are separated from the first sidewall panels 2 by a cut line 12. The attachment tabs 11 meet the second side wall panel 4 at a fold line 13 and are separated from a flange portion 14 by a fold line 15. These flange portions 14 are complementary to a central flange portion 16 separated from the first sidewall panel 2 by a fold line 17. This fold line 17 is much shorter than the central flange portion 16 given the presence of the two cut out portions shown in FIG. 1 to facilitate the folding of the central flange portion.

By contrast, the second flange 9 is formed of a single portion which is an extension of the second sidewall panel 4 and is separated from that panel by a fold line 18. As shown in FIG. 1, the second flange 9 has a central portion which is larger than its peripheral portion, but this is a stylistic detail which is not relevant to the present invention.

This facilitates the manufacturing method. As the tray moves down a gluing line with the foldable flanges at the side, the flanges are folded inwards by running along a bar that pushes the flange up and then curls over to take the flange into the middle of the pack i.e. to the position shown in FIG. 3. As the central portion of the second flange 9 extends beyond the rest of the container, the bar contacts the right part of the tray as described below. Other conventional methods such as using hooks and tippers can be used as described below.

In order to create the tray in the fold flat configuration, a number of folding and gluing operation are carried out on the blank as described below. Prior to this, the blank was formed in the form shown in FIG. 1 and all of the fold lines are created in the conventional manner by scoring, creasing or perforating the blank in the appropriate places.

From there, the first side wall panels 2 are folded inwardly about the fold line 3 into the position shown in FIG. 2. Glue is then applied to a region 20 (FIG. 3 one region shown, but this applies to all four tabs 11) either to an outer face of the first sidewall panel, or to an inner face of the attachment tab 11 and the attachment tabs 11 are folded in so that they fold along fold line 10 and are bonded to the respective first sidewall panels 2 resulting in the tray in the fold flat configuration as shown in FIG. 3.

The glue may be hot melt, cold (water based) glue or any type of suitable adhesive. The preferred method of folding the flaps is by the use of folding bar, but hooks and tippers may be used as an alternative depending on the direction of travel of the blank through the folding and gluing equipment. When folding bars are used, a first sidewall panel 2 is contacted at a part which is not subsequently covered by the attachment tabs. The folding of the attachment tabs 11 about the fold lines 10 either begins after the first side wall panels 2 are folded fully, or after the folding of the first side wall panels 2 has begun. In this case, the folding bar used to fold in the attachment tabs 11 can be used to complete the fold without requiring the involvement of the folding bar for the first sidewall panel.

Also, in this case, the adhesive will need to allow for sliding movement between the first side wall panel 2 and the attachment tabs 11 during the folding operation.

With the tray in the fold flat configuration shown in FIG. 3, it can be packed and transported.

In order to use the tray, it must be manipulated from the fold flat configuration of FIG. 3 to the erect configuration shown in FIGS. 4 and 5. In order to do this, it is simply a matter of holding the first flanges 8 (most conveniently by gripping the central flange portions 16) and separating them thereby manipulating the first flanges 8 to the position shown in FIGS. 4 and 5 where they form part of an out turned rim of the container.

As this happens, the tray folds about the fold lines 10 and 13 which pulls the second sidewall panels 4 inwards and upwards. The second flange 9 is pulled inwardly with its respective second sidewall portion and the user then folds the second flange 9 downwards to complete the outward rim. Before the flange is folded downwards, the second sidewall panel 4 can readily deform outwards tending to move the tray back to the fold flat position by folding around the lines 10 and 13. However, once the second flanges 9 are folded down, this locks the tray in place in that the tray can no longer fold about the fold line 10. This is because, once the second flange 9 is in this position, the part of the fold line 10 which is within the second flange 9 is no longer aligned with the part of the fold line 10 which is in the second sidewall panel 4. Thus, any outward movement of the second sidewall panel 4 about the fold line 10 in this configuration (i.e. any outward buckling of the second sidewall 4) will be attempting to resisted by the fact that this movement is attempting to deform the second flange 9 in the plane of the flange.

When in the erect configuration, the attachment tabs 11 overlay the ends of the first sidewall portion 2 as shown in FIG. 5 and the central flange portion 16 overlays the flange portions 14 which support the central flange portion 16 thereby providing additional rigidity to the ends of the tray.

In the fully erect configuration, a heat sealable film may be sealed to the first and second flanges 8, 9 which further enhances the rigidity of the container. Alternatively, an integral lid may extend from one of the flanges or a separate lid may be provided.

Where the board is uncoated, coated with a waterproof layer or laminated and the film subsequently cut along line 12 (see FIG. 1), it is suitable for use with products that do not require a hermetic seal to the tray.

As a variation to the design, the board can be cut along cut line 12 prior to lamination with a plastic film, and the plastic film can be adhered in a manner that leaves it unattached to the board on tab 11. This allows the film to fold back on itself to produce a continuous film web across the cut line 12 as first sidewall panels 2 and then subsequently attachment tabs 11 are folded inwards. The attachment tabs 11 are then glued on their sections closest to the centre of first sidewall panel 2 and the film forms a continuous web in the half of attachment tab 11 closest to fold line 13. This variation allows the tray to be hermetically sealed when a suitable lid or film is applied to the top of the formed tray. This can then be used for a leak proof, hermetic, or modified atmosphere tray.

1. A fold flat tray having an erect configuration and a fold flat configuration, the erect configuration comprising:
a base;
side walls comprising a pair of opposing first side walls and a pair of opposing second side walls between the pair of first side walls, respective first and second side walls meeting one another and the base at four corners each extending upwardly from a respective fold line at a respective edge of the base;
each side wall having, at the edge opposite the base, a flange extending outwardly from a fold line at the top edge of the respective side wall; and the fold flat configuration comprising:
the two opposing first side walls are folded inwardly about their respective fold lines adjacent to the base such that they lay flat against the base;
wherein each of the two opposing second side walls is provided with a straight fold line extending from each corner, across the second side wall and its associated flange in an oblique manner, such that each second side wall has a central portion between two straight fold lines, and two peripheral portions on opposite sides of the straight fold flat lines with respect to the central portion;
wherein in the fold flat configuration the peripheral portions fold down together with the respective adjacent first side walls so that the peripheral portions lie flat against the central portion of the adjacent second side wall; wherein each of the first side walls comprises a flange which is formed of a number of separate panels in the blank which are bonded together.

2. A tray according to claim 1, wherein the portions of the flange from the different panels overlap with one another.

3. A tray according to claim 2, wherein each of the first sidewalls has end panels which, in the blank, are continuations of the peripheral portion of the adjacent second side wall and, the end panels being bonded to a central panel forming the central part of the respective first side wall and which extends from the fold line at the base.

4. A tray according to claim 1, wherein each of the second side walls and the corresponding flange are formed of a single panel in the blank.

5. A tray according to claim 1, further comprising a lid attached to the rim of the tray.

6. A tray according to claim 5, wherein the lid is in the form of a plastics film which is adhered or heat sealed to the flanges.

7. A tray according to claim 1, made of a fibrous material.

8. A tray according to claim 7, wherein the fibrous material is cardboard.

9. A tray according to claim 1, further comprising a plastics layer on the inner face of the tray.

10. A tray according to claim 9, wherein the tray is formed of a laminate material with a film of plastics material to form the inner face of the tray.

11. A tray according to claim 10, wherein the laminate is applied after cutting the side panel of the tray, such that the film produces a partly adhered web of film in each corner when the tray is glued, allowing a hermetic seal to be achieved with a suitably applied lid.

12. A method of forming a fold flat tray according to claim 1 in its fold flat configuration, the method comprising forming a blank comprising the base, first and second side walls and flanges of the trays;
folding a central portion of each first side wall in so as to overlie the base; and
folding the second side walls about a respective straight fold line so that the number of separate panels forming a flange of each first side wall are brought together to form the flange.

13. A method according to claim 11, wherein when dependent on claim 3, wherein the step of folding the second side walls about the respective straight fold lines includes bringing the end panels into proximity with the central panel forming the central part of the respective first side wall and bonding these end panels to the central panel of the respective first side wall.
